(19) United States
(12) Patent Application Publication
(10) Pub. No.: US 2019/0150095 A1
(43) Pub. Date: May 16, 2019

(54) POWER MODE MANAGEMENT

(71) Applicants: Ming Yu Lin, Tustin, CA (US); Qiang Li, Irvine, CA (US)

(72) Inventors: Ming Yu Lin, Tustin, CA (US); Qiang Li, Irvine, CA (US)

(21) Appl. No.: 15/253,269

(22) Filed: Aug. 31, 2016

(51) Int. Cl. H04W 52/02

(52) U.S. Cl. CPC H04W 52/0274; H04W 52/0267; H04W 52/0225; H04W 52/0222

(57) ABSTRACT

A device is disclosed. The device includes one or more memories and one or more processors coupled to the one or more memories. The one or more processors are configured to cause, after a first amount of time elapses from entering a sleep mode of the device, exiting the sleep mode of the device. The one or more processors are further configured to cause receiving a first packet from a network device subsequent to exiting the sleep mode. The one or more processors are further configured to cause, in response to receiving the first packet, transmitting a second packet to the network device. The one or more processors are further configured to cause entering the sleep mode of the device subsequent to transmitting the second packet.

### CROSS REFERENCE TO RELATED APPLICATIONS

The present disclosure claims the benefit of U.S. Provisional Application No. 62/211,973, entitled “Power Off Sleep Management of an IoT SoC,” filed on Aug. 31, 2015, which is hereby incorporated by reference in its entirety.

### TECHNICAL FIELD

The present disclosure generally relates to power mode management and in particular, for example, to power mode management of a system on chip.

### BACKGROUND

Increasingly wireless systems are evaluated on their power consumption capabilities. A low power consumption wireless system is highly desired since this generally translates directly to a longer battery life of a wireless device. There are a number of techniques in the art to help lower the power consumption of a wireless device. For example, wireless systems may be designed to operate and switch between multiple modes, such as an active mode and a low power mode, where in the active mode the power consumption is higher than the low power mode. Another approach is to introduce a sleep mode once the system is detected not to be in an active mode or a low power mode. In some cases, in a sleep mode, only very few vital components are turned ON in anticipation of awakening the system to an active mode or a low power mode. In a sleep mode the power consumption of the system is at its minimal level.

However, power to operate in any of these modes is supplied from the battery, i.e. the source of energy of the wireless system, hence it is a limited source. Accordingly, there is a need in the art for an energy efficient protocol that will help to elongate the battery life and improve efficiency of the wireless system over all.

### SUMMARY

The disclosed subject matter relates to a device. The device includes one or more memories and one or more processors coupled to the one or more memories. The one or more processors are configured to cause, after a first amount of time elapses from entering a sleep mode of the device, exiting the sleep mode of the device by: increasing a voltage supplied to a power domain to a predetermined value; determining that a first boot sequence is to be performed based on an indication; and performing the first boot sequence. The one or more processors are further configured to cause receiving a first packet from a network device subsequent to exiting the sleep mode. The one or more processors are further configured to cause, in response to receiving the first packet, transmitting a second packet to the network device. The one or more processors are further configured to cause entering the sleep mode of the device subsequent to transmitting the second packet, wherein the entering the sleep mode comprises decreasing the voltage supplied to the power domain to a value less than the predetermined value.

The disclosed subject matter relates to a computer-implemented method. The method includes, after a first amount of time elapses from entering a sleep mode of a first device, exiting the sleep mode of the first device by: adjusting a voltage supplied to a power domain to a predetermined value; determining that a first boot sequence is to be performed based on an indication stored in the first device; and performing the first boot sequence. The method further includes facilitating maintaining a connection of the first device with a second device. The method further includes entering the sleep mode of the first device subsequent to the facilitating, wherein the entering the sleep mode comprises adjusting the voltage supplied to the power domain to a value different from the predetermined value.

It is understood that other configurations of the subject technology will become readily apparent to those skilled in the art from the following detailed description, wherein various configurations of the subject technology are shown and described by way of illustration. As will be realized, the subject technology of other different configurations and its several details are capable of modifications in various other respects, all without departing from the subject technology. Accordingly, the drawings and the detailed description are to be regarded as illustrative in nature and not restrictive.

### BRIEF DESCRIPTION OF DRAWINGS

Certain features of the present disclosure are set forth in the appended claims. However, for purpose of explanation, several implementations of the present disclosure are set forth in the following figures.

FIG. 1 illustrates an exemplary block diagram of an Internet of Things (IoT) system on chip (SoC) in accordance with one or more embodiments of the present disclosure.

FIG. 2 illustrates an exemplary block diagram that includes a power off control subsystem circuit of the IoT SoC in accordance with one or more embodiments of the present disclosure.

FIG. 3 illustrates an exemplary block diagram of a link layer controller (LLC) subsystem circuit of the IoT SoC in accordance with one or more embodiments of the present disclosure.

FIG. 4 illustrates a flowchart of boot sequences in accordance with one or more embodiments of the present disclosure.

FIG. 5 illustrates an example process for maintaining a connection.

FIG. 6 illustrates a flowchart of an example process for facilitating power mode management in accordance with one or more embodiments of the present disclosure.

FIG. 7 illustrates conceptually an example electronic system with which some implementations of the present disclosure can be implemented.

Embodiments of the present disclosure and their advantages are best understood by referring to the detailed description that follows. It should be appreciated that like-reference-numerals are used to identify like-elements illustrated in one or more of the figures.

### DETAILED DESCRIPTION

The detailed description includes specific details for the purpose of providing a thorough understanding of the present disclosure. However, the present disclosure is not limited to the specific details set forth herein and may be practiced without these specific details. In some instances, structures and components are shown in block diagram form to avoid obscuring the concept of the present disclosure.

In one or more implementations, the subject technology may facilitate power mode management, including a power off sleep management, of a system, including an Internet of Things (IoT) system on chip (SoC). In some aspects, apparatuses, systems and methods for reducing power consumption during standby operation are disclosed.

In one or more aspects, the power mode management may increase battery life and/or reduce battery size footprint requirement. The subject system may allow an increase in the battery life by allowing the use of harvest energy from radiated energy. In one or more aspects, the power mode management may allow for a more flexible on silicon foundry process selection, where determination criteria may be based on parameters such as speed and cost rather than on leakage current.

Other objects and advantages of the subject system will become obvious to the reader, and it is intended that these objects and advantages are within the scope of the subject system. To accomplish the above and related objects, the subject system may be embodied in the form illustrated in the accompanying drawings, attention being called to the fact, however, that the drawings are illustrative only, and that changes may be made in the specific construction illustrated and described within the scope of this application.

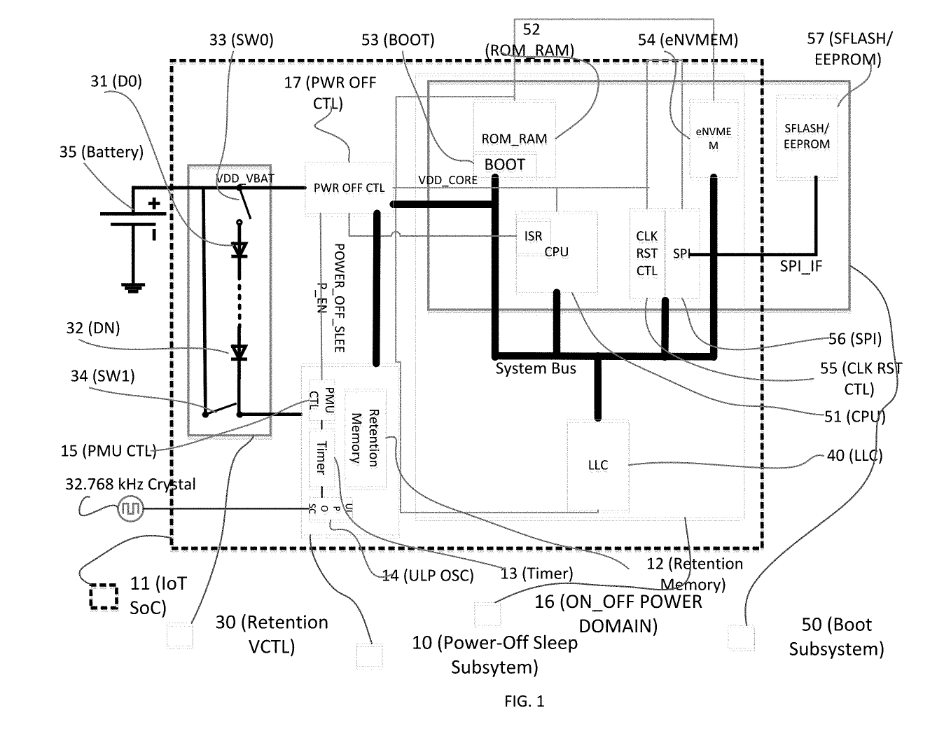

FIG. 1 illustrates an exemplary block diagram of an Internet of Things (IoT) system on chip (SoC) in accordance with one or more embodiments of the present disclosure. The IoT SoC 11 includes a power-off sleep subsystem circuit 10, power-off control (PWR OFF CTL) subsystem circuit 17, retention voltage control (Retention VCTL) subsystem circuit 30, link layer controller (LLC) subsystem circuit 40, and boot subsystem circuit 50.

The power-off sleep subsystem circuit 10 may manage entering and exiting of the sleep mode of the IoT SoC 11. In the sleep mode, components of the IoT SoC 11 are powered off, except for a power domain that houses logics and memory in order for the IoT SoC 11 to be restored when the IoT SoC 11 exits the sleep mode. The power domain that remains powered in the sleep mode may be relatively small in size (e.g., relatively small compared to an entire area of the IoT SoC 11) and/or may house a minimal amount of logics and memory. The power-off sleep subsystem 10 is in a power domain that remains on when the IoT SoC 11 is in the sleep mode. In one aspect, a power domain that remains on when the IoT SoC 11 is in the sleep mode may be referred to as being always on. In one aspect, transistors (e.g., all transistors) in the power-off sleep subsystem 10 may be higher voltage threshold transistors to reduce leakage current. In one aspect, in exiting the sleep mode, the IoT SoC 11 may be restored to the state of the IoT SoC 11 just prior to entering the sleep mode. For example, higher voltage threshold core transistors may have a threshold voltage of around 0.35 V to around 0.45 V. Higher voltage threshold input/output (I/O) transistors may have a threshold voltage of around 0.7 V to around 0.8 V.

The power-off sleep subsystem 10 may draw voltage supply from a power domain that remains on even when the IoT SoC 11 is in the sleep mode. The power-off sleep subsystem 10 may include logics and memory utilized to support sleep mode operation of the IoT SoC 11. The power-off sleep subsystem 10 may include an electronic oscillator (ULP OSC) circuit 14. In some cases, the electronic oscillator 14 may be an ultra-low power (ULP) oscillator (OSC). In one aspect, the electronic oscillator circuit 14 utilizes a mechanical resonance of a vibrating crystal to generate an electrical signal of a desired frequency. The power-off sleep subsystem 10 may include a timer circuit 13 that runs off of the electronic signal (e.g., clock signal) generated by the electronic oscillator circuit 14. The timer circuit 13 may keep track of a sleep duration, which may refer to a duration of the time at which the IoT SoC 11 remains in the sleep mode. The electronic signal may be a 32.768 kHz clock signal from a crystal oscillator where power is a function of frequency.

The power-off sleep subsystem 10 may include a power management unit control (PMU CTL) circuit 15. The PMU CTL circuit 15 may be, or may include, a state machine utilized for managing when to enter/exit the sleep mode (e.g., based on a pre-programmed/predetermined timer value). In an aspect, the pre-programmed/predetermined timer value may be set based on a connection interval (e.g., time for a next packet to be sent or received). The connection interval may be determined by a computer processing unit (CPU) 51. The power-off sleep subsystem 10 may include a retention memory 12 that stores all of the states needed to restore the system operation of the IoT SoC 11 after the IoT SoC 11 exits the sleep mode.

In one aspect, the timer circuit 13 may include logics implemented using thick-oxide transistors, which are generally associated with higher threshold voltage. In one aspect, the PMU CTL control circuit 15, electronic oscillator circuit 14, and retention memory 12 may include thick-oxide transistor bit cell(s), which are generally associated with higher threshold voltage. For example, higher voltage threshold core transistors may have a threshold voltage of around 0.35 V to around 0.45 V. Higher voltage threshold I/O transistors may have a threshold voltage of around 0.7 V to around 0.8 V. The leakage of higher threshold voltage transistors is generally lower than the leakage of transistors with lower threshold voltage. A transistor's threshold voltage depends on its design and process technology. For example, by increasing the threshold voltage by 100 mV, the leakage may be reduced by a factor of about 10. In some cases, an increase in the threshold voltage of a transistor by about 100 mV may be associated with an increase in the switching time of the transistor by about 15% and/or a penalty of area (e.g., transistor with higher threshold voltage take up more chip real estate).

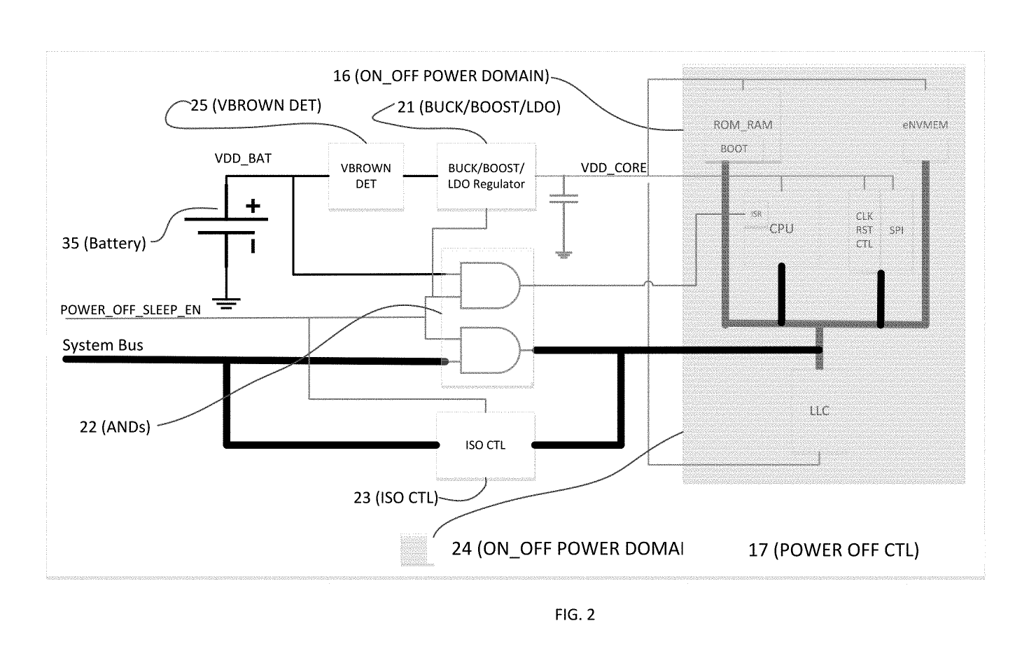

FIG. 2 illustrates an exemplary block diagram that includes the PWR OFF CTL subsystem circuit 17 of the IoT SoC 11 in accordance with one or more embodiments of the present disclosure. The PWR OFF CTL subsystem circuit 17 may be utilized to shut off a voltage from a battery 35 applied to an ON_OFF POWER DOMAIN 16 and properly gate and isolate signals entering and exiting the ON_OFF POWER DOMAIN 16 to prevent undesired leakage current.

In one aspect, when the IoT SoC 11 is run from a small coin cell battery, the leakage current associated with the sleep mode operation may be in the sub-micro ampere range to allow the battery life of one or multiple years. To achieve a low leakage, most of the components of the IoT SoC 11 may need to be shut down.

The ON_OFF POWER DOMAIN 16 may include all the logics and memories, including a central processing unit (CPU) 51, read-only memory and random-access memory (ROM RAM) 52, embedded non-volatile memory (eNVMEM) 54, clock reset control (CLK RST CTL) circuit 55, serial peripheral interface (SPI) 56, and LLC subsystem circuit 40. A voltage VDD_CORE applied to the ON_OFF POWER DOMAIN 16 may be controlled by the PWR OFF CTL subsystem circuit 17, where the voltage VDD_CORE is shutoff (e.g., reduced to zero) or otherwise decoupled from the ON_OFF POWER DOMAIN 16 when the IoT SoC 11 is in the sleep mode and turned on or otherwise coupled to the ON_OFF POWER DOMAIN 16 during the normal operation. In one aspect, the PWR OFF CTL subsystem circuit 17 may include a regulator (BUCK/BOOST/LDO) circuit 21, such as a buck (step-down) regulator circuit, boost (step-up) regulator circuit, or low-dropout regulator circuit, to control the voltage VDD_CORE.

A signal POWER_OFF_SLEEP_EN from the PMU CTL circuit 15 may be used to enter the sleep mode. For example, the PMU CTL 15 circuit may be used to disable the regulator in the PWR OFF CTL subsystem 17. The signal POWER_OFF_SLEEP_EN may be used to isolate output signals in an isolation control (ISO CTL) circuit 23 to either logic 1 or 0 with latches so the output signals are not floating. Isolation may include logic isolation to address situations in which logics with power drive unpowered logics (which can cause unwanted leakage) and/or unpowered logics drive powered logics (which can cause unwanted signal toggling and thus cause unwanted current consumption). The signal POWER_OFF_SLEEP_EN also gates input signals before entering the ON_OFF POWER DOMAIN 16 via a combinatorial circuit 22 (e.g., AND gates) so that the input signals have a reduced or no possibility of driving a drain or source terminal of a transistor (e.g., complementary metal-oxide-semiconductor (CMOS) transistor), thus preventing creation of a leakage path. A voltage brown out detector (VBROWN DET) circuit 25 monitors a voltage VDD_BAT of the battery 35 to ensure that no voltage brown out condition occurs. If a voltage brown out condition occurs, the VBROWN DET circuit 25 may cause the regulator circuit 21 to be shut down and allow the IoT SoC 11 to reset and restart a power up sequence. The voltage brown out condition may occur when the VDD_BAT falls below a threshold value (e.g., below 1.7 V).

The retention VCTL subsystem circuit 30 may include a diode D0 31, a diode D1 32, a switch SW0 33, and a switch SW1 34. The retention VCTL subsystem circuit 30 may lower the voltage supplied by the battery 35 to a minimal retention voltage. The retention VCTL subsystem circuit 30 may supply the minimal retention voltage to the power domain that is always on within the IoT SoC 11 when the IoT SoC 11 is in the sleep mode.

A current associated with the sleep mode operation may come from the leakage current. In one aspect, the current associated with the sleep mode operation may be reduced by lowering a voltage (e.g., applied to the logics and memories) to just above a minimal requirement (e.g., minimal voltage retention requirement) for maintaining logic state of flip flop(s) and/or memory bit cell(s). For example, the logic state and memory state may be retained as long as the voltage remains above a threshold voltage (e.g., above around 0.4 V for core transistors and above around 0.8 V for I/O transistors). In some cases, the voltage may be reduced without using an active circuit(s) to allow the current consumption of the retention VCTL subsystem circuit 30 to be minimal. Depending on the voltage supplied by the battery 35 and minimal retention voltage requirement for a given CMOS foundry process (e.g., 65 nm), a series of diodes D0 31, . . . , DN32 can be used. One or more or no diodes may be between the diode D0 31 and diode DN 32. The voltage supplied by the battery 35 may be lowered by Vt*N, where Vt is the threshold voltage of the diodes D0 and DN and N is the number of diodes in the series of diodes. In the sleep mode, the switch SW0 33 may be closed while the switch SW1 34 may be open to allow the reduced voltage from an output of the series of diodes 31 and 32. In the normal mode, the switch SW0 33 may be open while the switch SW1 34 may be closed to allow the series diodes 31 and 32 to be bypassed.

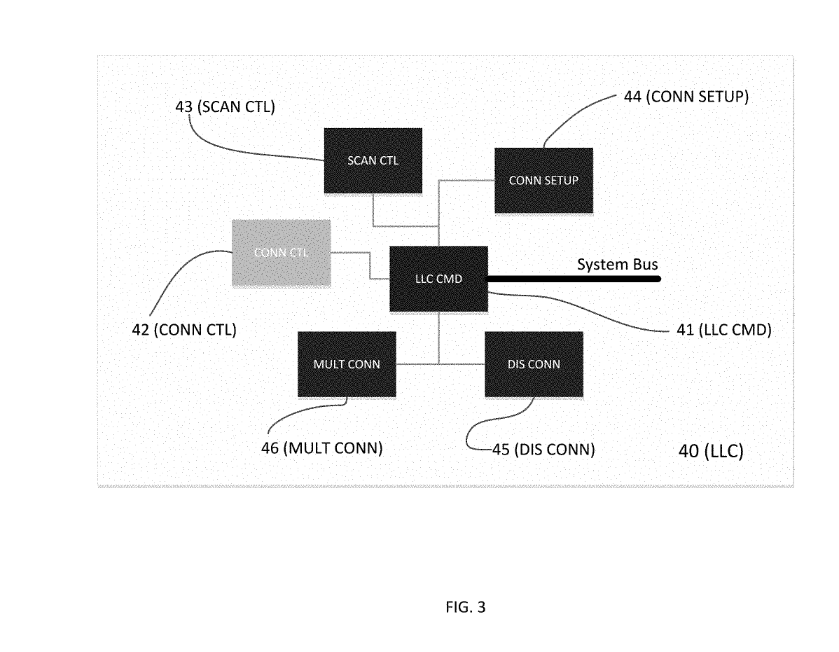

FIG. 3 illustrates an exemplary block diagram of the LLC subsystem circuit 40 of the IoT SoC 11 in accordance with one or more embodiments of the present disclosure. The LLC subsystem circuit 40 may be a link layer controller for managing wireless link connections (e.g., WiFi, Bluetooth, Zigbee). The LLC subsystem 40 may include an LLC command (CMD) circuit 41, a connection controller (CONN CTL) circuit 42, a scan controller (SCAN CTL) circuit 43, a connection setup (CONN SETUP) circuit 44, a disconnect (DIS CONN) circuit 45, and a multiple connection (MULT CONN) circuit 46.

Upon receiving a command(s) from the CPU 51 via a system bus, the LLC subsystem circuit 40 may scan, set up a connection, maintain a connection, and/or tear down a connection. In one aspect, the LLC subsystem circuit 40 can support one or more links simultaneously. Once a command is received and processed by the LLC CMD circuit 41, the LLC CMD 41 may launch an appropriate state machine for a given command, which is a separate state machine for scanning done by the SCAN CTL circuit 43, setting up a connection done by the CONN SETUP circuit 44, maintaining a connection done by the CONN CTL circuit 42, tearing down a connection done by the DIS CONN circuit 45, and maintaining multiple connections done by the MULT CONN circuit 46.

For an IoT application, a most common usage scenario may be to maintain a connection to a wireless network in case there is data to be pulled by the wireless network to the IoT SoC 11 or pushed by the IoT SoC 11 to the wireless network. In some cases, for a majority of operation time, the IoT SoC 11 may go in and out of the sleep mode just to stay connected to the wireless network. In some cases, system complexity is reduced in the sleep mode operation and the entire operation to maintain the connection can be handled almost entirely by the CONN CTL 42 circuit. Since there is no data to be processed, majority of software stacks including application code are not needed. In this regard, IoT applications are generally associated with control and status update, and required throughput data is generally small most of the time. The link is connected and waiting for data to be received or sent (e.g., 1 second connection interval) so there is no real data to be serviced. When the system needs to exit from the sleep mode, a small amount of information may be needed to get the IoT SoC 11 back to the state where it is maintaining a connection to the wireless network. The IoT SoC 11 can also minimize the restoration time when it restores from a fixed and known state, such as system reset (cold boot) state, where it is more feasible for a usage scenario, such as to maintain a network connection.

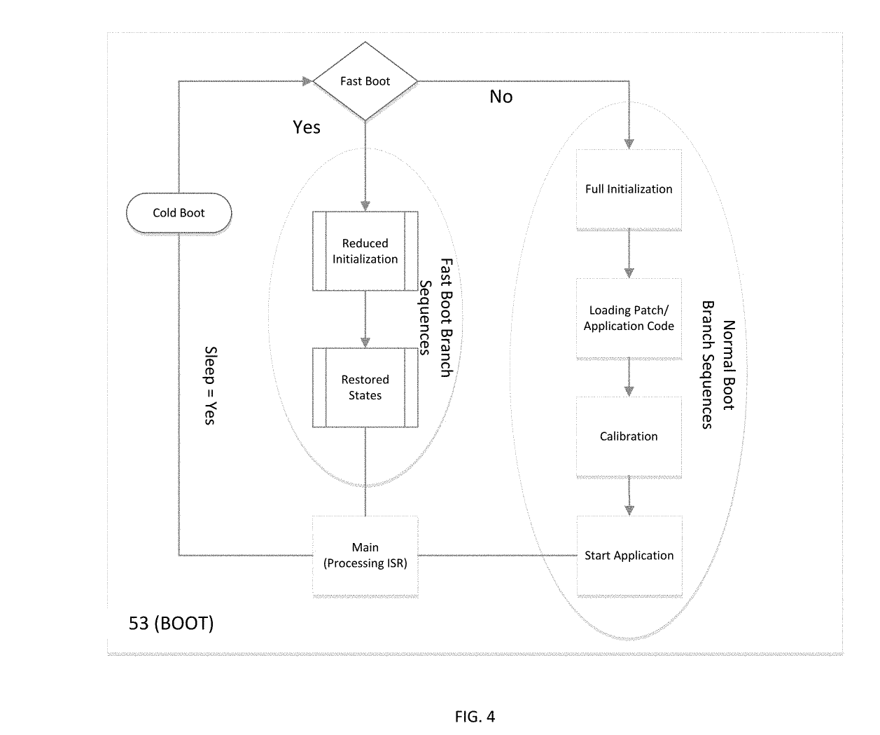

FIG. 4 illustrates a flowchart of boot sequences in accordance with one or more embodiments of the present disclosure. When the IoT SoC 11 is powered up, the boot subsystem circuit 50 may be utilized to initialize the IoT SoC 11 and launch services utilized for the desired operation.

When a voltage is applied to the boot subsystem circuit 50, the CLK RST CTL circuit 55 may start to run while holding a rest of the boot subsystem circuit 50 in reset. In some cases, reset may refer to a signal for ensuring that the IoT SoC 11 is set to a default state when the IoT SoC 11 is powered. A proper reset sequence may need to be designed to allow power up to occur correctly and consistently. In an aspect, logics (e.g., a small amount of logics, such as a small state machine-like CLK_RST_CTL to ensure reset is valid after the logics have proper voltages and clocks). Depending on whether the IoT SoC 11 starts (e.g., boots up) a first time or the IoT SoC 11 just exits the sleep mode, the CLK RST CTL circuit 55 may wait for either an expiration of a crystal (XTAL) timer or stabilization of a resistor capacitor oscillator (RC OSC) to release a reset to the CPU 51. In some cases, the XTAL timer (e.g., XTAL warmup timer) may be stored in a register programmed by the CPU 51 before the IoT SoC 11 going to sleep. In an aspect, the XTAL timer may be a default value hardwired for a power up condition. To ensure there is ample time for the crystal to be warmed up, the CLK RST CTL circuit 55 may wait for a certain time. After the crystal clock stabilizes, the CLK RST CTL circuit 55 can release the reset (e.g., reset signal) to properly reset the IoT SoC 11. In some implementations, the IoT SoC 11 may be considered to start a first time when the IoT SoC 11 is being turned on from a shutdown state, in which an entirety (e.g., all components) of the IoT SoC 11 is powered off. In contrast, in the sleep mode, some components of the IoT SoC 11 remain turned/powered on (e.g., not in the shutdown state). Once the reset is released, the CPU 51 can start executing code, denoted as BOOT 53, residing in the ROM RAM 52. In an aspect, the BOOT 53 may be stored in ROM of the ROM RAM 52.

In some cases, the BOOT 53 is a first part of a code image (e.g., stored in ROM of the ROM RAM 52) that handles the boot process of the IoT SoC 11. Within the BOOT 53, there are two boot branches (a normal boot branch and a fast boot branch) from a system reset state (cold boot), with each branches associated with a respective flow sequence from the system reset state. In an aspect, the system reset state may be a state in which reset is applied, and may be a default starting condition of the IoT SoC 11. In some cases, as shown in FIG. 4, both branches arrive at a main service function after completion of either branch sequence. The main service routine function the system reset state when the IoT SoC 11 enters into the sleep mode. In an aspect, the main service routing function may be a main loop where the CPU 51 is jumping into after initialization. In the main service routing function, the CPU 51 starts to execute pending tasks if there are any or just wait for tasks to be performed.

The boot process performed by the boot subsystem circuit 50 may involve a delay due to waiting for the XTAL to be warmed up. In some cases, the XTAL may be utilized only for active RF transmission and reception. In order to reduce a delay caused by the XTAL warmup, a clock generated from a resistive-capacitive (RC) oscillator may be utilized to facilitate faster warm up time. In some cases, digital logics may have more jitter tolerance compared to analog or RF circuits. When the IoT SoC 11 is starting for the first time, utilization of the XTAL may be safer because it is more stable than an RC oscillator.

The boot process may involve loading of patch/application code from an external non-volatile memory, such as an SFLASH/EEPROM 57. In some implementations, the external non-volatile memory may be utilized when there is no embedded non-volatile memory eNVMEM 54 (e.g., one time programmable memory or flash memory); otherwise, the patch/application code may be loaded from the embedded non-volatile memory eNVMEM 54. In some cases, depending on the code size and/or the interface used to load the code into the internal ROM_RAM 52 (e.g., RAM of the ROM_RAM 52), the loading of code can be very time consuming. The common interface used for loading is the SPI 56. To avoid slowing down the loading (e.g., such as for the fast boot branch), some patches (e.g., critical patches) can be retained in the retention memory 21 so that these patches do not have to be loaded.

Depending on if the IoT SoC 11 is starting for the first time or is exiting the sleep mode, the CPU 51 may execute instructions from either the normal boot branch sequences or fast boot branch sequences of the BOOT 53, as shown in FIG. 4. In order for the CPU 51 to determine which branch to execute, the PMU CTL 24 may store an indication (e.g., a flag) utilized to help the IoT SoC 11 select either the normal boot branch sequences or the fast boot branch sequences shown in the FIG. 4. The indication may be set to a first value to indicate selecting the normal boot branch sequence and may be set to a second value different from the first value to indicate selecting the fast boot branch sequences. In this regard, the indication may be a flag that is set to the first value or the second value. In one aspect, when the IoT SoC 11 is exiting the sleep mode, information saved in the retention memory 21 may be utilized to allow the fast boot branch sequences to be performed rather than the normal boot branch sequences. In this regard, the normal boot branch sequences may include a full initialization task (e.g., full initialization of hardware and firmware of the IoT SoC 11), a loading patch and application code task (e.g., loading patch and application a non-volatile memory), a calibration task (e.g., calibrating all hardware), and a start/launch application task (e.g., including launching service functions). The fast boot branch sequences may include a reduced initialization task (instead of a full initialization task) and may involve skipping tasks like loading patch/application code and calibration to gain a faster starting time.

In some aspects, the power-off sleep subsystem circuit 10 may control the operation of the PWR OFF CTL subsystem circuit 17 and the retention VCTL subsystem circuit 30 using dedicated signals, such as the POWER_OFF_SLEEP_EN signal. The retention VCTL subsystem circuit 30 may reduce the voltage used by the power-off sleep subsystem circuit 10 and the ISO CTL circuit 23 and the combinatorial circuit 22 in the PWR OFF CTL subsystem circuit 17.

The PWR OFF CTL subsystem circuit 17 manages voltage supplied to the ON_OFF_POWER DOMAIN 16 using the regulator 21. In an aspect, the signals (e.g., all the signals) going in and out of the ON_OFF_POWER DOMAIN 16 may go through the PWR OFF CTL subsystem circuit 20. In an aspect, the ON_OFF POWER DOMAIN 16 may include the domain (e.g., power domain, voltage domain) for the CPU 51, ROM_RAM 52, eNVMEM 54, CLK RST CTL 55, SPI 56, and LLC subsystem circuit 40. The voltage supply connection may be all tied together, where the supply line is being shut off during sleep mode and turned on during normal mode of operation.

The power-off sleep subsystem circuit 10, LLC subsystem circuit 40, and boot subsystem circuit 50 may be connected through the system bus.

To reduce a number of states to be preserved, a function such as maintaining a network connection is illustrated as an example, but any function that is used frequently can also be selected as well. In a given system, such as in the IoT SoC 11, one or multiple functions can also be defined where each different function has different set of reduced states to be preserved for each usage scenario.

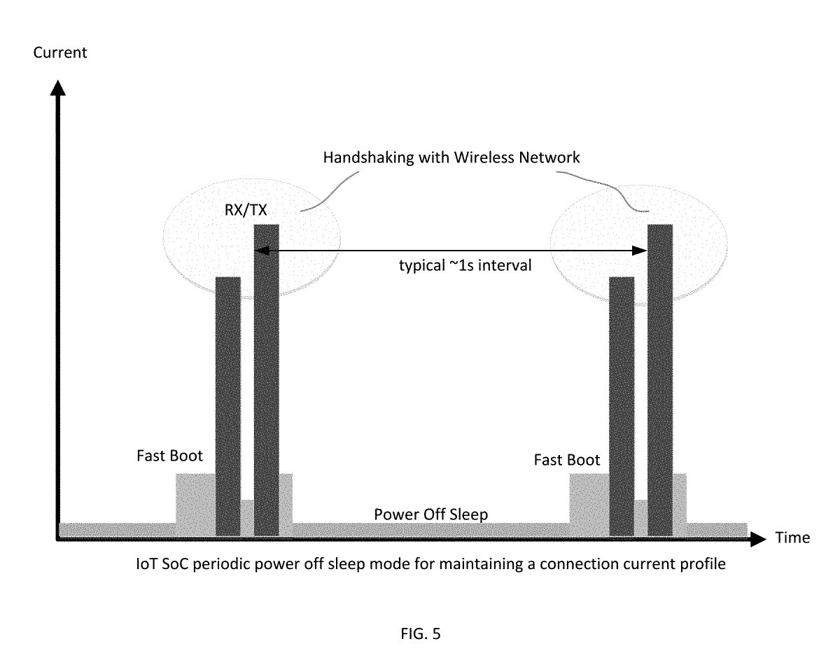

In some IoT applications, a system may be awakened from a sleep state/mode to determine if there is any activity to service, such as data acquisition activity (e.g., retrieving data or pushing data). Assuming data acquisition frequency is low, the system may stay in the sleep mode a majority of the time while periodically being awakened to maintain synchronization (e.g., stay in synchronization) between the system and a network (e.g., wireless network). Maintaining synchronization may allow the system to continue to be associated with the network or be connected to the network. This repetitive activity with long interval period can be better illustrated in FIG. 5 through a current consumption profile of an IoT SoC for maintaining a connection to a network. In this regard, FIG. 5 illustrates an example process for maintaining a connection.

When the IoT SoC 11 is starting for the first time, the IoT SoC 11 has to go through the normal boot cycle. For example, in the normal boot cycle, the IoT SoC 11 may include time to allow a voltage to be stabilized, crystal to be properly warmed up, a full initialization for both hardware and firmware to be completed, loading of patch and application code from the SFLASH/EEPROM 57 (e.g., assuming the embedded non-volatile memory eNVMEM 54 is not present), calibrating all the hardware, and launching all the service functions including launching applications. The IoT SoC 11 finds appropriate wireless network to be connected to and registers itself to the wireless network. After an initial setup is completed (e.g., from an application layer all the way down to a physical layer), the CPU 51 may remain in a main loop waiting for new trigger event. In some cases, for a majority of the time, the main service routine has nothing to service, except for servicing a function for maintaining synchronization with (e.g., maintaining a connection to) the network (as illustrated, for example, in FIG. 5). In FIG. 5, there are operations associated with two parts. When FIG. 5 is applied to the IoT SoC 11, in a first part, the IoT SoC 11 is sleeping. In a second part, the IoT SoC 11 is awake to perform a network synchronization task by exchanging packets (e.g., over the air packets). In some cases, an operation of interest is how to minimize sleep mode current consumption and how to minimize latency from exit of the sleep mode to enter the normal mode.

In one or more implementations, operation starts before going to the sleep mode. The CONN CTL circuit 42 in the LLC subsystem circuit 40 may save/store an indication (e.g., a flag) in the PMU CTL circuit 15 indicating that, upon a next wake cycle, the IoT SoC 11 is only expected to service a single function of maintaining a connection (e.g., an existing association with a network). In an aspect, a sleep duration may be pre-programmed in the timer circuit 13 and states that the IoT SoC 11 utilizes to restore the IoT SoC 11 (e.g., when exiting the sleep mode) have already been identified and allocated to reside in the retention memory 12.

The PMU CTL circuit 15 in the power-off sleep subsystem circuit 10 may initiate entering the sleep mode by isolating and gating all signals going in and out of the ON_OFF POWER DOMAIN 16. The PMU CTL circuit 15 may control the voltage supplied to the ON_OFF POWER DOMAIN 16 by controlling (e.g., disabling) a regulator(s) (e.g., the regulator 21) such that the regulator(s) cut off the voltage supply to the ON_OFF POWER DOMAIN 16. The PMU CTL circuit 15 may instruct the retention VCTL subsystem circuit 30 to lower battery voltage (e.g., of the battery 35) by enabling the switches SW0 33 and SW2 34. At this time, the timer circuit 13 may begin to decrement a pre-programmed (e.g., predetermined) counter. The PMU CTL circuit 15 may wait for the counter to expire (e.g., a predetermined amount of time to elapse) to exit the sleep mode. As an example, in a case that the timer circuit 13 is programmed to count down from 33333 and runs of a 32.768 kHz clock signal from the ULP OSC circuit 14, the counter decrements to zero in about 1 second. After around 1 second, when the timer circuit 13 counts down to 0, the PMU CTL circuit 15 may be triggered to begin the sleep mode exit process.

In the sleep mode exit process, the PMU CTL circuit 15 may bring the voltage back by disabling the series diodes D0 31 through DN 32 by opening the switch SW0 33 and closing the switch SW1 34. The PMU CTL circuit 15 may enable the regulator 21. The PMU CTL circuit 15 may releases gating and isolation logics to the ON_OFF_POWER_DOMAIN 16. When the voltage VDD_CORE supplied to the ON_OFF_POWER_DOMAIN 16 reaches a predetermined level, the CLK RST CTL circuit 55 timer of the boot subsystem circuit 50 may start to count down by decrementing a counter. Once the counter reaches 0, the CLK RST CTL circuit 55 may release the reset to the CPU 51, and the CPU 51 may start to execute the BOOT 53 out of the ROM_RAM 52 (e.g., ROM of the ROM_RAM 52). In executing the BOOT 53, the CPU 51 may check for an indication (e.g., a flag) saved in the PMU CTL circuit 15 as to whether to execute the normal boot or fast boot. Since the IoT SoC 11 is exiting the sleep mode, the CPU 51 may execute the fast boot branch of sequences of the BOOT 53, including executing a reduced initialization task and a task to restore states back to the CONN CTL circuit 42 in the LLC subsystem circuit 40 and ROM_RAM 52 (e.g., RAM of the ROM_RAM 52). The CONN CTL circuit 42 may prepare to re-synchronize to the network by receiving a beacon and/or an anchored packet from the network. Upon receiving the beacon and/or the anchored packet, the CONN CTL circuit 42 may prepare an acknowledgment packet to be sent back to the network (e.g., a server associated with the network). The exchange between the CONN CTR circuit 42 and the network, which involves exchange of a beacon and/or an anchored packet and an associated acknowledgement packet, may be referred to as a handshake between the IoT SoC 11 and the network. Once the handshake completes, the connection to the network is sustained. If there is no pending data to be received or transmitted, the IoT SoC 11 may re-enter the sleep mode. The operation of going in and out of the sleep mode to maintain one or more network connections repeated until there is either data to be pushed (e.g., to the network) or there is data to be received (e.g., from the network). When either condition occurs, the IoT SoC 11 may change the state of the indication (e.g., disable the fast boot flag) and boot the IoT SoC 11 into the normal mode and perform the normal boot branch sequences. In some cases, the IoT SoC 11 may know that there is data to be received based on a pre-negotiated link protocol, such as a connection interval or beacon interval (e.g., scheduled time to service a link). In general, the normal boot process takes a longer duration compared to the fast boot process. Once the IoT SoC 11 completes data processing, the IoT SoC 11 may change the indication (e.g., re-enable the fast boot flag) and the procedure of going in and out of the sleep mode to maintain a connection resumes.

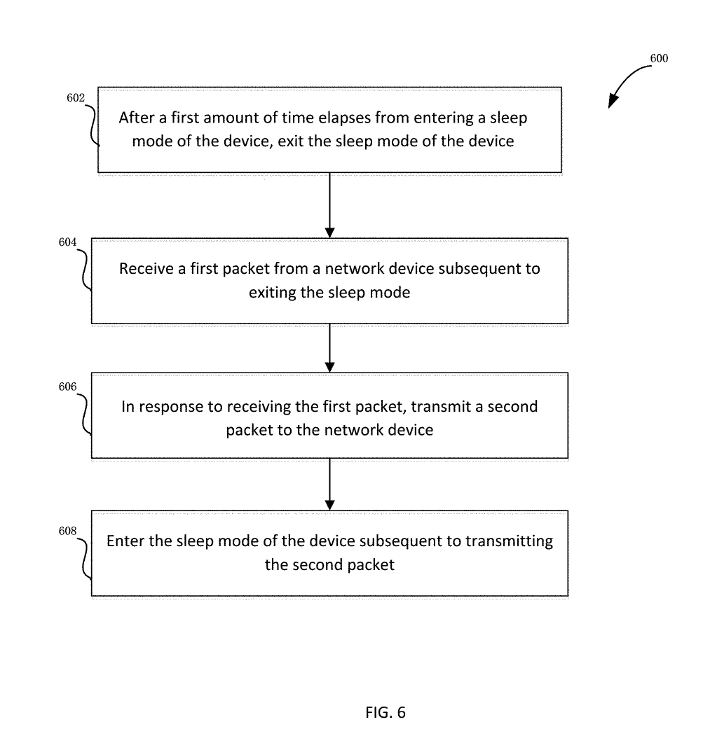

FIG. 6 illustrates a flowchart of an example process for facilitating power mode management in accordance with one or more embodiments of the present disclosure. The IoT SoC 11 may be in a sleep mode. At step 602, after a first amount of time elapses from the IoT SoC 11 entering the sleep mode, the IoT SoC 11 may exit the sleep mode. In an aspect, the PMU CTL circuit 15 may cause the IoT SoC 11 to enter the sleep mode. In an aspect, the IoT SoC 11 may exit the sleep mode once a counter of the timer circuit 13 reaches a predetermined value. For instance, the IoT SoC 11 may exit the sleep mode when the counter is decremented to zero.

Exiting the sleep mode may include increasing a voltage supplied to the ON_OFF_POWER_DOMAIN 16 to reach a predetermined level. For instance, the increase in voltage may result from the PMU CTL circuit 15 disabling the series diodes D0 31 through DN 32 by opening the switch SW0 33 and closing the switch SW1 34 and/or enabling the regulator 21. Exiting the sleep mode may include determining whether to perform a normal boot or a fast boot. The CPU 51 may determine which boot sequence to perform based on an indication (e.g., a flag). The indication may be stored in the PMU CTL circuit 15. The CPU 51 may then execute the instructions of the determined boot sequence.

At step 604, the IoT SoC 11 may receive a first packet from a network device subsequent to exiting the sleep mode. At step 606, the IoT SoC 11 may transmit a second packet to the network device in response to the first packet. The second packet may be an acknowledgement packet. In an aspect, the first packet and the second packet may be part of a handshaking procedure to maintain a connection between the IoT SoC 11 and the network device to maintain. At step 608, the IoT SoC 11 may enter the sleep mode subsequent to transmitting the second packet.

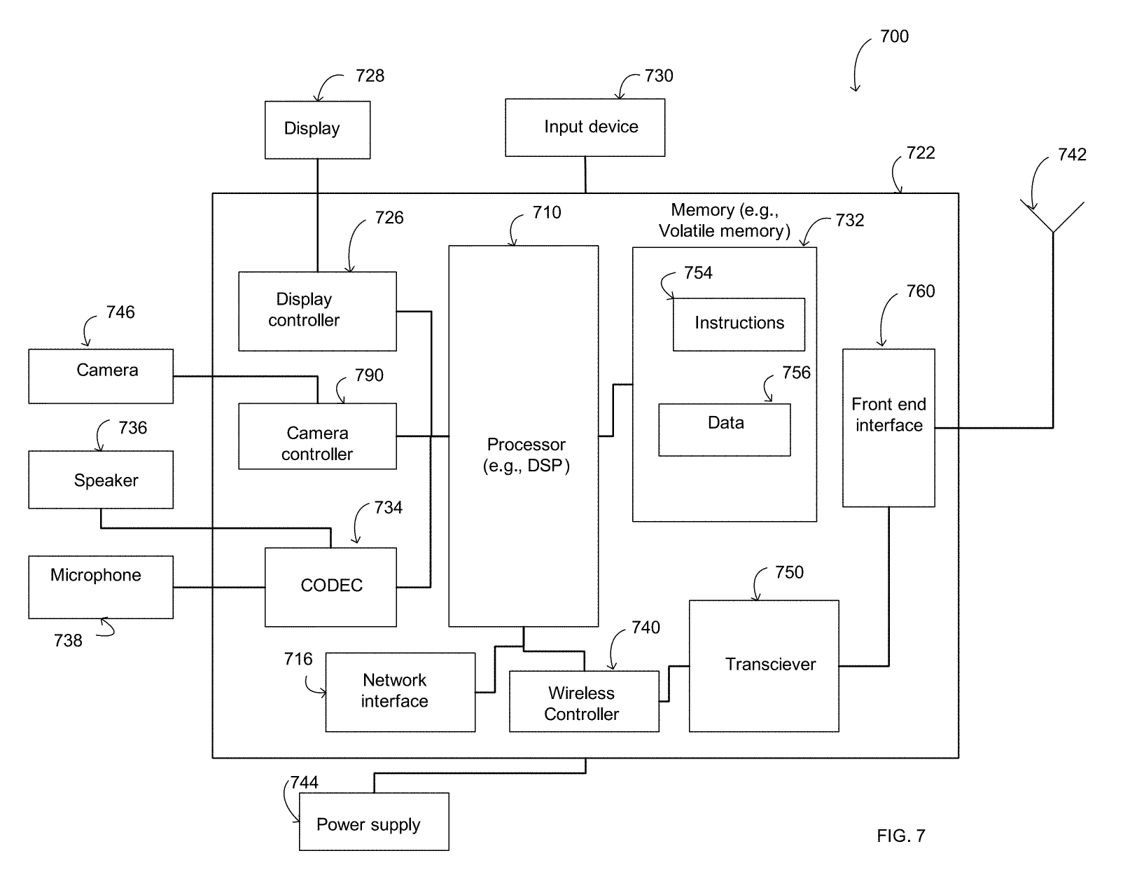

FIG. 7 illustrates conceptually an example electronic system 700 with which some implementations of the present disclosure can be implemented. The electronic system 700 can be a gateway device, a set-top box, a computer (e.g., desktop computer or laptop computer), a phone, a personal digital assistant (PDA), a server, a switch, a router, a base station, a receiver, or any other sort of electronic device that transmits signals over a network, such as electronic devices embedded in smart appliances and other smart systems. The electronic system 700 can be, can include, and/or can be a part of, the IoT SoC 11 of FIG. 1. Such an electronic system includes various types of computer readable media and interfaces for various other types of computer readable media.

The electronic system 700 may include a processor 710, such as a digital signal processor (DSP). The processor 710 may be coupled to a computer-readable storage medium, such as a memory 732 (e.g., a non-transitory computer-readable medium), via a transceiver 750. Moreover, as depicted in FIG. 7, the processor 710 may be external to the transceiver 750. For example, the processor 710 may be “off-chip” with respect to the transceiver 750. In another embodiment, the processor 710 and the transceiver 750 are integrated within a system-in-package or system-on-chip device 722, as explained further below. In some aspects, the system-on-chip device 722 may be, may include, or may be a part of, the IoT SoC 11.

The memory 732 may store instructions 754 that are executable by the processor 710, data 756 that is accessible to the processor 710, or a combination thereof. In a particular embodiment, the memory 732 is a volatile memory that is accessible to the processor 810 via the transceiver 750. FIG. 7 also shows a display controller 726 that is coupled to the processor 710 and to a display 728. A coder/decoder (CODEC) 734 can also be coupled to the processor 710. A speaker 736 and a microphone 738 can be coupled to the CODEC 734. FIG. 7 also indicates that a wireless controller 740 can be coupled to the processor 710. The wireless controller may be further coupled to an antenna 742 via the transceiver 750. A camera 846 may be coupled to a camera controller 790. The camera controller 790 may be coupled to the processor 710.

In a particular embodiment, the processor 710, the memory 732, the display controller 726, the camera controller 790, the CODEC 734, the wireless controller 740, and the transceiver 750 are included in the system-in-package or system-on-chip device 722. An input device 730 and a power supply 744 may be coupled to the system-on-chip device 722. Moreover, in a particular embodiment, and as illustrated in FIG. 7, the display 728, the input device 730, the camera 746, the speaker 736, the microphone 738, the antenna 742, and the power supply 744 are external to the system-on-chip device 722. However, each of the display 28, the input device 730, the camera 746, the speaker 736, the microphone 738, the antenna 742, and the power supply 844 can be coupled to a component of the system-on-chip device 722. As a particular example, the processor 710 and the memory 732 are coupled to transceiver 750.

In connection with the present disclosure, a computer-readable storage medium (e.g., the memory 732) stores data (e.g., the data 756) that is accessible to a processor (e.g., the processor 710).

Finally, as shown in FIG. 7, the electronic system 700 couples to a network through a network interface 716. In this manner, the electronic system 700 can be a part of a network of computers (for example, a local area network (LAN), a wide area network (WAN), or an Intranet, or a network of networks, for example, the Internet. Any or all components of electronic system 700 can be used in conjunction with the subject disclosure. The network interface 716 can include cellular interfaces, WiFi interfaces, Infrared interfaces, RFID interfaces, ZigBee interfaces, Bluetooth interfaces, Ethernet interfaces, coaxial interfaces, optical interfaces, or generally any communication interface that can be used for device communication.

Those of skill in the art will appreciate that the foregoing disclosed systems and functionalities may be designed and configured into computer files (e.g. RTL, GDSII, GERBER, etc.) stored on computer-readable media. Some or all such files may be provided to fabrication handlers who fabricate devices based on such files. Resulting products include semiconductor wafers that are separated into semiconductor dies and packaged into semiconductor chips. The semiconductor chips are then employed in devices, such as the IoT SoC 11, the electronic system 700, or a combination thereof.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor, and the storage medium may reside as discrete components in a computing device or user terminal.

Further, specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Where applicable, various embodiments provided by the present disclosure may be implemented using hardware, software, or combinations of hardware and software. In addition, where applicable, the various hardware components and/or software components, set forth herein, may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A device, comprising:
one or more memories; and
one or more processors coupled to the one or more memories, the one or more processors configured to cause:
after a first amount of time elapses from entering a sleep mode of the device, exiting the sleep mode of the device by:
increasing a voltage supplied to a power domain to a predetermined value;
determining that a first boot sequence is to be performed based on an indication; and
performing the first boot sequence;
receiving a first packet from a network device subsequent to exiting the sleep mode;
in response to receiving the first packet, transmitting a second packet to the network device; and
entering the sleep mode of the device subsequent to transmitting the second packet, wherein the entering the sleep mode comprises decreasing the voltage supplied to the power domain to a value less than the predetermined value.

2. The device of claim 1, wherein the indication is set to a first value to indicate that the first boot sequence is to be performed, wherein the one or more processors are further configured to cause:
determining presence of at least one of data to be received by the device from the network device or data to be transmitted by the device to the network device;
setting the indication to a second value to indicate that the second boot sequence is to be performed based on determining presence of at least one of data to be received by the device from the network device or data to be transmitted by the device to the network device; and
performing the second boot sequence to exit the sleep mode of the device.

3. The device of claim 2, wherein the one or more operations are further configured to cause:
setting the indication to the first value when one or more transactions associated with the at least one of data to be received by the device from the network device or data to be transmitted by the device to the network device are completed; and
entering the sleep mode of the device.

4. The device of claim 2, wherein performance of the second boot sequence is associated with a longer duration than performance of the first boot sequence.

5. The device of claim 1, wherein the performing the first boot sequence occurs after a second amount of time elapses from the voltage reaching the predetermined value.

6. The device of claim 1, wherein the first packet and the second packet facilitate maintaining a connection between the device and the network device.

7. The device of claim 1, wherein the second packet comprises an acknowledgement packet to the first packet.

8. The device of claim 1, wherein the voltage supplied to the power domain is based on an operational state of a regulator and a plurality of diodes.

9. The device of claim 1, wherein the entering the sleep mode further comprises setting a counter value indicative of the first amount of time.

10. The device of claim 9, wherein the one or more processors are further configured to cause:
adjusting the counter value until the first amount of time elapses, wherein the counter value is at a predetermined value when the first amount of time elapses; and
exiting the sleep mode of the device when the counter value is at the predetermined value.

11. The device of claim 1, wherein the indication is stored in the device.

12. A computer-implemented method, comprising:
after a first amount of time elapses from entering a sleep mode of a first device, exiting the sleep mode of the first device by:
adjusting a voltage supplied to a power domain to a predetermined value;
determining that a first boot sequence is to be performed based on an indication stored in the first device; and
performing the first boot sequence;
facilitating maintaining a connection of the first device with a second device; and
entering the sleep mode of the first device subsequent to the facilitating, wherein the entering the sleep mode comprises adjusting the voltage supplied to the power domain to a value different from the predetermined value.

13. The method of claim 12, wherein the indication is set to a first value to indicate that the first boot sequence is to be performed, wherein the method further comprises:
determining presence of at least one of data to be received by the first device from the second device or data to be transmitted by the first device to the second device;
setting the indication to a second value to indicate that the second boot sequence is to be performed based on determining presence of at least one of data to be received by the first device from the second device or data to be transmitted by the first device to the second device; and
performing the second boot sequence to exit the sleep mode of the second device.

14. The method of claim 13, further comprising:
setting the indication to the first value when one or more transactions associated with the at least one of data to be received by the first device from the second device or data to be transmitted by the first device to the second device are completed; and
entering the sleep mode of the first device.

15. The method of claim 13, wherein performance of the second boot sequence is associated with a longer duration than performance of the first boot sequence.

16. The method of claim 12, wherein the performing the first boot sequence occurs after a second amount of time elapses from the voltage reaching the predetermined value.

17. The method of claim 12, wherein the facilitating maintaining the connection of the first device with the second device comprises:
receiving a first packet from the second device subsequent to exiting the sleep mode; and
transmitting a second packet to the second device, wherein the second packet comprises an acknowledgement packet to the first packet.

18. The method of claim 12, wherein the voltage supplied to the power domain is based on an operational state of a regulator and a plurality of diodes.

19. The method of claim 12, wherein the entering the sleep mode further comprises setting a counter value indicative of the first amount of time.

20. The method of claim 19, further comprising:
adjusting the counter value until the first amount of time elapses, wherein the counter value is at a predetermined value when the first amount of time elapses; and
exiting the sleep mode of the first device when the counter value is at the predetermined value.
